(19) United States
(12) Patent Application Publication
(10) Pub. No.: US 2016/0216583 A1
(43) Pub. Date: Jul. 28, 2016

(54) LIQUID CRYSTAL DISPLAY PANEL, MANUFACTURING METHOD FOR THE SAME, AND LIQUID CRYSTAL DISPLAY DEVICE

(71) Applicant: Shenzhen China Star Optoelectronics Technology Co. , Ltd., Shenzhen (CN)

(72) Inventors: Jiali JIANG, Shenzhen (CN); Peng DU, Shenzhen (CN); Ming-Hung SHIH, Shenzhen (CN)

(73) Assignee: Shenzhen China Star Optoelectronics Technology Co. , Ltd., Shenzhen (CN)

(21) Appl. No.: 14/375,915

(22) PCT Filed: May 16, 2014
(86) PCT No.: PCT/CN2014/077635

§ 371 Date: Jul. 31, 2014

(30) Foreign Application Priority Data
Apr. 10, 2014 (CN) 201410143419.2

(51) Int. Cl. G02F 1/1362; G02F 1/1335; G02F 1/1333; G02F 1/1368

(52) U.S. Cl. CPC G02F 1/136286; G02F 1/1368; G02F 1/133514; G02F 1/133345

(57) ABSTRACT

The LCD panel of the present invention includes an array substrate, a color film substrate, and a liquid crystal layer. The array substrate includes a substrate, a data line, a scanning line, a pixel electrode, a thin-film field-effect transistor, and an insulative layer. The pixel electrode corresponds to a first area of the array substrate. The data line, the scanning line, and the thin-film field-effect transistor correspond to a second area of the array substrate. The thickness of the insulative layer on the first area is less than the thickness of the insulative layer on the second area. Liquid crystal usage is reduced by reducing the thickness of the insulative layer on the first area of the array substrate in the present invention.

### BACKGROUND OF THE INVENTION

1. Field of the Invention

The present invention relates to a field of liquid crystal technology, and more specifically to a liquid crystal display (LCD) panel, a manufacturing method for the same, and an LCD device.

2. Description of the Prior Art

Due to the development of liquid crystal display technology, there are more and more users using LCD devices. In comparison to other flat panel displays, breakthroughs are achieved in many technologies of LCD devices in recent years, and thereby the performance of LCD devices have obviously improved. Thus, the market share of LCD devices has increased substantially.

When an existing LCD device is manufactured, the higher lightness and the faster response-time of the LCD device can be obtained by selecting a suitable thickness of a liquid crystal cell. In which, a liquid crystal material is filled in a closed space between a color film substrate and an array substrate to form a liquid crystal cell having a suitable thickness. The thickness of the liquid crystal cell here is a distance between the transparent electrode of the color film substrate and the transparent electrode of the array substrate.

However, the liquid crystal material in the LCD device is as a component having higher purchase costs, that affects not only the performance of the LCD device but also the manufacturing costs of the LCD device. Therefore, the liquid crystal used in each liquid crystal panel has been a key factor by which costs can be reduced for panel manufacturers. The panel manufacturers hope to design an LCD device which can ensure the performance of the LCD panel, and is also capable of reducing the liquid crystal usage.

Therefore, there is a need to provide an LCD panel, a manufacturing method for the same, and an LCD device, so as to overcome the disadvantage in the prior art.

### SUMMARY OF THE INVENTION

An object of the present invention is to provide a LCD panel, a manufacturing method for the same, and a LCD device that is capable of reducing a liquid crystal usage, thereby solving the technical problems of poor display performance or higher costs of existing LCD panels and the LCD devices thereof.

To overcome the above-mentioned disadvantages, the technical schemes provided by the present invention are hereunder illustrated.

The embodiment of the present invention provides an LCD panel, which includes an array substrate, a color film substrate, and a liquid crystal layer sandwiched between the array substrate and the color film substrate. The array substrate includes:

a substrate;
a data line for transferring a data signal;
a scanning line for transferring a scanning signal;
a pixel electrode for applying a deflection voltage to the liquid crystal layer;
   a thin-film field-effect transistor for applying the data signal to the pixel electrode; and
   an insulative layer disposed on the substrate, the insulative layer being for providing a separation between the data line, the scanning line, the pixel electrode, and the thin-film field-effect transistor. The pixel electrode corresponds to the first area of the array substrate. The data line, the scanning line, and the thin-film field-effect transistor correspond to the second area of the array substrate. The thickness of the insulative layer on the first area is less than the thickness of the insulative layer on the second area.

In the LCD panel according to one embodiment of the present invention, the insulative layer is only deposited on the second area.

In the LCD panel according to one embodiment of the present invention, the pixel electrode is directly deposited on the substrate when the insulative layer is only deposited on the second area.

In the LCD panel according to one embodiment of the present invention, the input of the thin-film field-effect transistor is connected to the data line, the output of the thin-film field-effect transistor is connected with the pixel electrode by a contact hole, and the control terminal of the thin-film field-effect transistor is connected to the scanning line.

In the LCD panel according to one embodiment of the present invention, the material of the insulative layer includes silicon nitride or silicon oxide.

The embodiment of the present invention further provides a method for manufacturing an array substrate. The method includes:

depositing a first metal layer onto a substrate, and then forming a scanning line by a patterning process;
depositing a first insulative layer, an active layer, and a second metal layer, and then forming a data line and a thin-film field-effect transistor by a patterning process;
depositing a second insulative layer, and then forming a contact hole by a patterning process, and the thickness of the insulative layer on the first area of the array substrate being less than the thickness of the insulative layer on the second area of the array substrate, wherein the insulative layer includes the first insulative layer and the second insulative layer, and the data line, the scanning line, and the thin-film field-effect transistor correspond to the second area of the array substrate; and
depositing a transparent electrode layer, and then forming a pixel electrode onto the first area of the array substrate by a patterning process.

In the method according to the embodiment of the present invention for manufacturing the array substrate, the thickness of the insulative layer on the first area of the array substrate is zero.

In the method according to the embodiment of the present invention for manufacturing the array substrate, the pixel electrode is directly deposited on the substrate when the thickness of the insulative layer on the first area of the array substrate is zero.

In the method according to the embodiment of the present invention for manufacturing the array substrate, the input of the thin-film field-effect transistor is connected to the data line, the output of the thin-film field-effect transistor is connected with the pixel electrode by the contact hole, and the control terminal of the thin-film field-effect transistor is connected to the scanning line.

In the method according to the embodiment of the present invention for manufacturing the array substrate, the material of the first metal layer includes aluminum metal and molybdenum metal.

In the method according to the embodiment of the present invention for manufacturing the array substrate, the material of the insulative layer includes silicon nitride or silicon oxide.

In the method according to the embodiment of the present invention for manufacturing the array substrate, the material of the active layer is poly-silicon.

In the method according to the embodiment of the present invention for manufacturing the array substrate, the material of the second metal layer includes aluminum metal and molybdenum metal.

The embodiment of the present invention further provides an LCD device, which includes a backlight module and an LCD panel. The LCD panel includes an array substrate, a color film substrate, and a liquid crystal layer sandwiched between the array substrate and the color film substrate. The array substrate includes:

a substrate;
a data line for transferring a data signal;
a scanning line for transferring a scanning signal;
a pixel electrode for applying a deflection voltage to the liquid crystal layer;
a thin-film field-effect transistor for applying the data signal to the pixel electrode; and
an insulative layer disposed on the substrate, the insulative layer being for providing a separation between the data line, the scanning line, the pixel electrode, and the thin-film field-effect transistor. The pixel electrode corresponds to the first area of the array substrate. The data line, the scanning line, and the thin-film field-effect transistor correspond to the second area of the array substrate. The thickness of the insulative layer on the first area is less than the thickness of the insulative layer on the second area.

In the LCD device of the present invention, the insulative layer is only deposited on the second area.

In the LCD device of the present invention, the pixel electrode is directly deposited on the substrate when the insulative layer is only deposited on the second area.

In the LCD device of the present invention, the input of the thin-film field-effect transistor is connected to the data line, the output of the thin-film field-effect transistor is connected with the pixel electrode by a contact hole, and the control terminal of the thin-film field-effect transistor is connected to the scanning line.

In the LCD device of the present invention, the material of the insulative layer includes silicon nitride or silicon oxide.

In comparison to the existing LCD panel and the LCD device thereof, liquid crystal usage is reduced by reducing the thickness of the insulative layer on the first area of the array substrate in the LCD panel, the manufacturing method for the same, and the LCD device of the present invention, thereby solving the technical problem of poor display performance or higher costs of the existing LCD panel and the LCD device thereof.

The above objectives, and other objectives, features, advantages, and embodiments of the present invention will be better understood from the following description being considered in connection with the accompanied drawings, and in which a preferred embodiment of the invention is illustrated by way of example.

### BRIEF DESCRIPTION OF THE DRAWINGS

FIG. 1A is a schematic view of a structure of an existing LCD panel;

FIG. 1B is a profile view of a cross-section A-A′ of FIG. 1A;

FIG. 1C is a profile view of a cross-section B-B′ of FIG. 1A;

FIG. 2A is a schematic view of a structure of an LCD panel according to a first preferred embodiment of the present invention;

FIG. 2B is a profile view of a cross-section C-C′ of FIG. 2A;

FIG. 2C is a profile view of a cross-section D-D′ of FIG. 2A;

FIG. 3A is a schematic view of a structure of an LCD panel according to a second preferred embodiment of the present invention;

FIG. 3B is a profile view of a cross-section E-E′ of FIG. 3A;

FIG. 3C is a profile view of a cross-section F-F′ of FIG. 3A; and

FIG. 4 is a flow chart of a method according to a preferred embodiment of the present invention for manufacturing an array substrate.

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, “left”, “right”, “inside”, “outside”, “side”, etc., is used with reference to the orientation of the Figure(s) being described. As such, the directional terminology is used for purposes of illustration and is in no way limiting.

Throughout this specification and in the drawings like parts will be referred to by the same reference numerals.

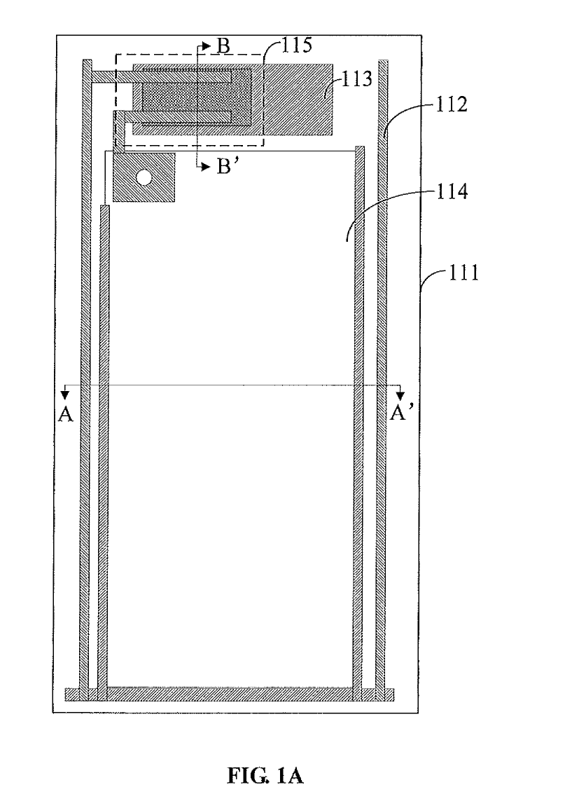

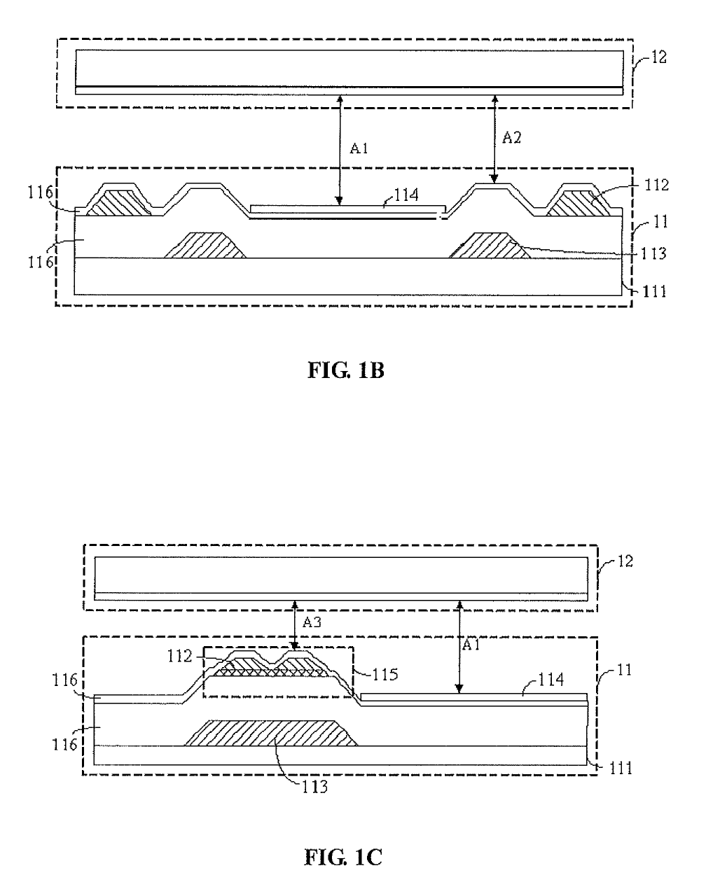

Please refer to FIGS. 1A to 1C. FIG. 1A is a schematic view of a structure of an existing LCD panel. FIG. 1B is a profile view of a cross-section A-A′ of FIG. 1A. FIG. 1C is a profile view of a cross-section B-B′ of FIG. 1A. The LCD panel includes an array substrate 11, a color film substrate 12, and a liquid crystal layer (not shown in the figure) sandwiched between the array substrate 11 and the color film substrate 12. The array substrate 11 includes a substrate 111, a data line 112, a scanning line 113, a pixel electrode 114, a thin-film field-effect transistor 115, and an insulative layer 116. The data line 112 is disposed on the substrate 111, and the data line 112 is for transferring a data signal. The scanning line 113 is disposed on the substrate 111, and the scanning line 113 is for transferring a scanning signal. The pixel electrode 114 is disposed on the substrate 111, and the pixel electrode 114 is for applying a deflection voltage to the liquid crystal layer. The thin-film field-effect transistor 115 is for applying the data signal to the pixel electrode 114. The insulative layer 116 is also disposed on the substrate 111, and is for providing a separation between the data line 112, the scanning line 113, the pixel electrode 114, and the thin-film field-effect transistor 115.

Please refer to FIGS. 1B and 1C, a distance between the color film substrate 12 and the pixel electrode 114 of the array substrate 11 is A1. The distance A1 is to ensure the minimum distance of the display quality of the LCD panel. This means the display quality of the LCD panel will be reduced when the distance between the color film substrate 12 and the pixel electrode 114 of the array substrate 11 is re-reduced. At this point, a distance between the color film substrate 12 and the thin-film field-effect transistor 115 of the array substrate 11 is A3. A distance between the color film substrate 12 and an area of the data line 112 and the scanning line 113 of the array substrate 11 is A2. Therefore, spaces between the color film substrate 12 and the areas of the array substrate 11 that are corresponded to the pixel electrode 114, the thin-film field-effect transistor 115, the data line 112, and the scanning line 113 are filled up with a liquid crystal material. At this point, the liquid crystal usage is a minimum liquid crystal usage of the LCD panel according to the structure.

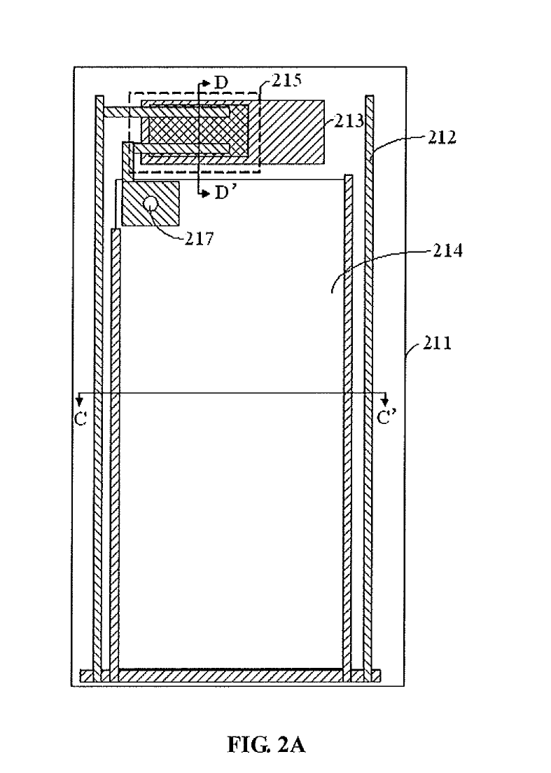

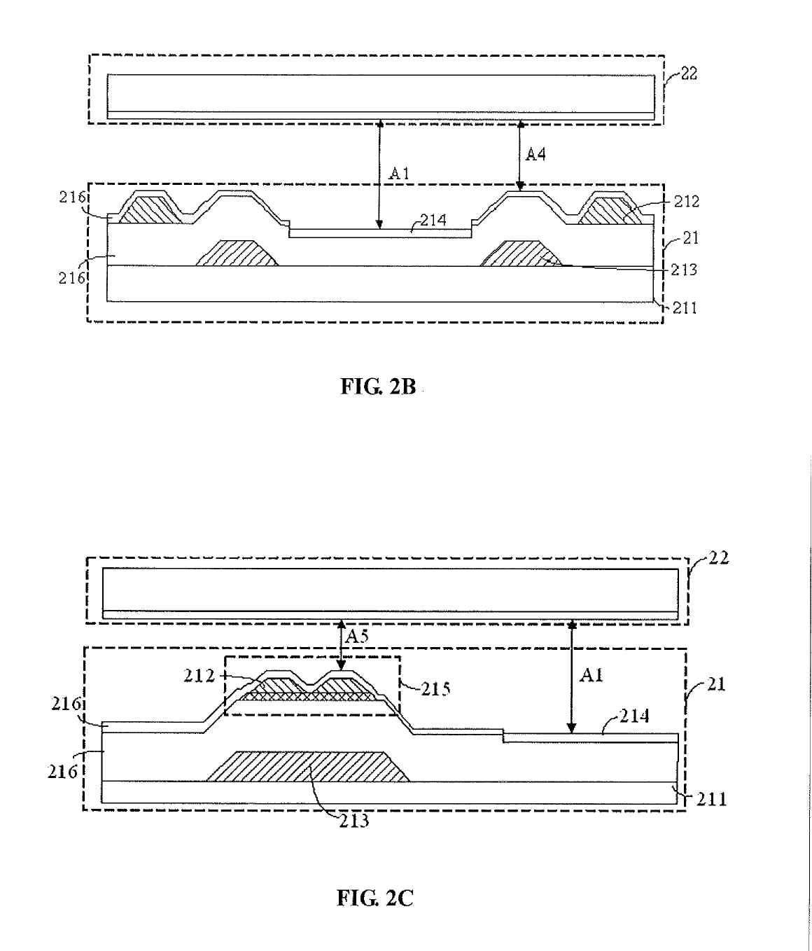

Please refer to FIGS. 2A to 2C. FIG. 2A is a schematic view of a structure of an LCD panel according to a first preferred embodiment of the present invention. FIG. 2B is a profile view of a cross-section C-C′ of FIG. 2A. FIG. 2C is a profile view of a cross-section D-D′ of FIG. 2A. In which, a substrate 211, a data line 212, a scanning line 213, a pixel electrode 214, a thin-film field-effect transistor 215, and an insulative layer 216 are included in an array substrate 21. The LCD panel of the preferred embodiment is based on the existing LCD panel, the thickness of the insulative layer 216 deposited on the first area of the array substrate 21 is less than the thickness of the insulative layer 216 on the second area of the array substrate 21. The pixel electrode 214 corresponds to the first area of the array substrate 21. The data line 212, the scanning line 213, and the thin-film field-effect transistor 215 correspond to the second area of the array substrate 21.

The input of the thin-film field-effect transistor 215 is connected to the data line 212. The output of the thin-film field-effect transistor 215 is connected with the pixel electrode 214 by the contact hole 217 on the insulative layer 216. The control terminal of the thin-film field-effect transistor 215 is connected to the scanning line 213.

Please refer to FIG. 2B. A distance between a color film substrate 22 and the pixel electrode 214 of the array substrate 21 is still A1, which ensures the display quality of the LCD panel. However, the thickness of the insulative layer 216 on an area (i.e., the first area of the array substrate 21) corresponding to the pixel electrode 214 is less than the thickness of the insulative layer 216 on an area (i.e., the second area of the array substrate 21) corresponding to the data line 212 and the scanning line 213. A distance between the color film substrate 22 and an area of the data line 212 and the scanning line 213 of the array substrate 21 is A4. At this point, A4 must be less than A2. “A2-A4” means a difference in thickness between the insulative layer 216 on the first area of the array substrate 21 and the insulative layer 216 on the second area of the array substrate 21.

Please refer to FIG. 2C. The distance between the color film substrate 22 and the pixel electrode 214 of the array substrate 21 is still A1, which ensures the display quality of the LCD panel. However, the thickness of the insulative layer 216 on the area (i.e., the first area of the array substrate 21) corresponding to the pixel electrode 214 is less than the thickness of the insulative layer 216 on an area (i.e., the second area of the array substrate 21) corresponding to the thin-film field-effect transistor 215. A distance between the color film substrate 22 and an area of the thin-film field-effect transistor 215 of the array substrate 21 is A5. At this point, A5 must be less than A3. “A3-A5” means a difference in thickness between the insulative layer 216 on the first area of the array substrate 21 and the insulative layer 216 on the second area of the array substrate 21.

At this point, the liquid crystal usage should be less than a minimum liquid crystal usage of the LCD panel according to the existing structure when spaces between the color film substrate 22 and the areas of the array substrate 21 that are corresponded to the pixel electrode 214, the thin-film field-effect transistor 215, the data line 212, and the scanning line 213 are filled up with a liquid crystal material.

Therefore, the liquid crystal usage of the LCD panel can be reduced by reducing the thickness of the insulative layer on the first area of the array substrate in the LCD panel of the preferred embodiment.

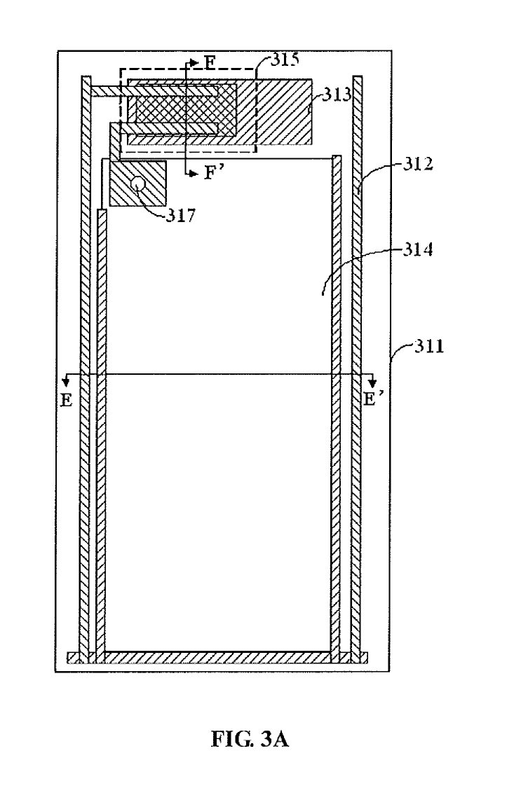

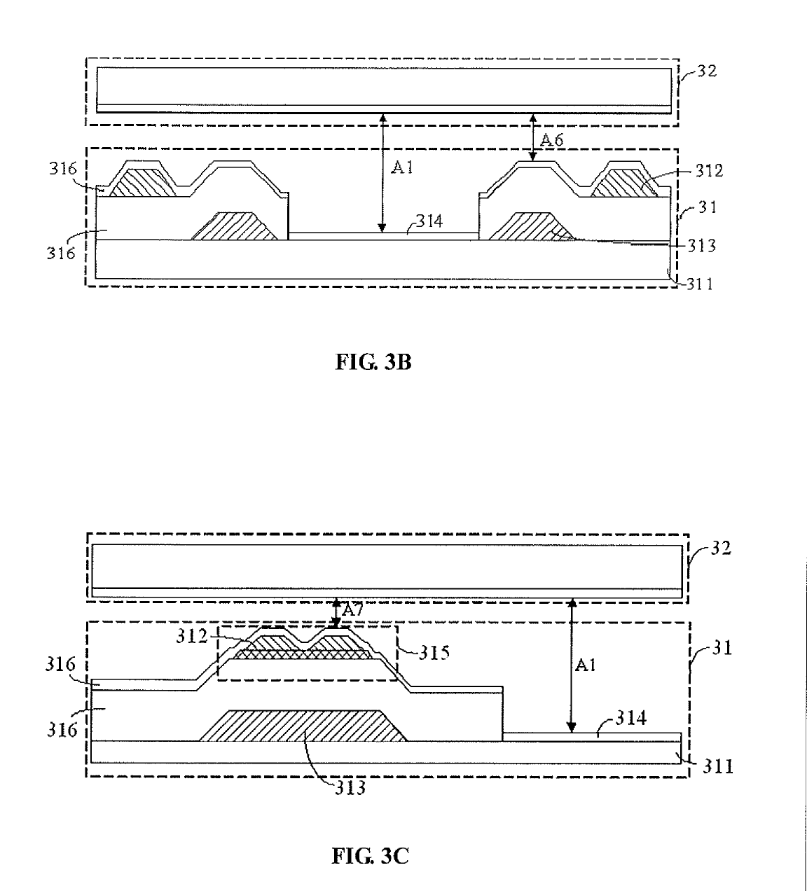

Please refer to FIGS. 3A to 3C. FIG. 3A is a schematic view of a structure of an LCD panel according to a second preferred embodiment of the present invention. FIG. 3B is a profile view of a cross-section E-E′ of FIG. 3A. FIG. 3C is a profile view of a cross-section F-F′ of FIG. 3A. The LCD panel of the preferred embodiment is based on the existing LCD panel, the thickness of an insulative layer 316 deposited on the first area of an array substrate 31 is less than the thickness of the insulative layer 316 on the second area of the array substrate 31. In which, a pixel electrode 314 is corresponded to the first area of the array substrate 31. A data line 312, a scanning line 313, and a thin-film field-effect transistor 315 are corresponded to the second area of the array substrate 31. In a preferred embodiment of the present invention, the thickness of the insulative layer 316 on the first area of the array substrate 31 is zero. The insulative layer 316 is only deposited on the second area of the array substrate 31. The pixel electrode 314 is directly deposited on a substrate 311.

The input of the thin-film field-effect transistor 315 is connected to the data line 312. The output of the thin-film field-effect transistor 315 is connected with the pixel electrode 314 by the contact hole 317 on the insulative layer 316. The control terminal of the thin-film field-effect transistor 315 is connected to the scanning line 313.

Please refer to FIG. 3B. A distance between a color film substrate 32 and the pixel electrode 314 of the array substrate 31 is still A1, which ensures the display quality of the LCD panel. However, the thickness of the insulative layer 316 on an area (i.e., the first area of the array substrate 31) corresponding to the pixel electrode 314 is zero. A distance between the color film substrate 32 and an area of the data line 312 and the scanning line 313 of the array substrate 31 is A6. At this point, A6 must be less than A2. “A2-A6” means a thickness of the insulative layer 316 on the second area of the array substrate 31.

Please refer to FIG. 3C. A distance between a color film substrate 32 and the pixel electrode 314 of the array substrate 31 is still A1, which ensures the display quality of the LCD panel. However, the thickness of the insulative layer 316 on an area (i.e., the first area of the array substrate 31) corresponding to the pixel electrode 314 is zero. A distance between the color film substrate 32 and an area of the thin-film field-effect transistor 315 of the array substrate 31 is A7. At this point, A7 must be less than A3. “A3-A7” means a thickness of the insulative layer 316 on the second area of the array substrate 31.

At this point, the liquid crystal usage should be less than a minimum liquid crystal usage of the LCD panel according to the existing structure, and should also be less than a minimum liquid crystal usage of the first preferred embodiment of the LCD panel, when spaces between the color film substrate 32 and the areas of the array substrate 31 that are corresponded to the pixel electrode 314, the thin-film field-effect transistor 315, the data line 312, and the scanning line 313 are filled up with a liquid crystal material.

Therefore, in the LCD panel of the preferred embodiment, based on the first preferred embodiment, the liquid crystal usage of the LCD panel can be further reduced by reducing the thickness of the insulative layer on the first area of the array substrate.

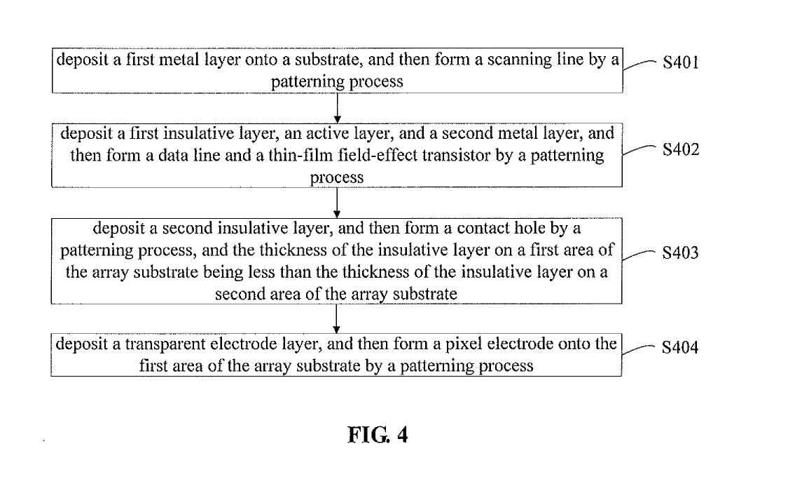

Please refer to FIG. 4. FIG. 4 is a flow chart of a method according to a preferred embodiment of the present invention for manufacturing an array substrate. The method according to the preferred embodiment for manufacturing the array substrate is used for manufacturing the array substrate of the above LCD panel. The method includes the following steps.

In step S401, a first metal layer is deposited on a substrate, and then a scanning line is formed by a patterning process.

In step S402, a first insulative layer, an active layer, and a second metal layer are deposited, and then a data line and a thin-film field-effect transistor are formed by a patterning process.

In step S403, a second insulative layer is deposited, and then a contact hole is formed by a patterning process. The thickness of the insulative layer on the first area of the array substrate is less than the thickness of the insulative layer on the second area of the array substrate.

In step S404, a transparent electrode layer is deposited, and then a pixel electrode is formed on the first area of the array substrate by a patterning process.

The method according to the preferred embodiment for manufacturing the array substrate is ended with step S404.

A specific process of each step in the method according to the preferred embodiment for manufacturing the array substrate will be described in further detail hereinafter.

In step S401, the first metal layer is deposited on the substrate, and then the first metal layer is graphic-processed, thereby the scanning line is formed on the substrate. Preferably, the first metal layer is made of an aluminum metal layer and a molybdenum metal layer. Other materials such as aluminum (Al), silver (Ag), copper (Cu), molybdenum (Mo), chromium (Cr), tungsten (W), tantalum (Ta), titanium (Ti), metal nitride, or any combination thereof can also be utilized, as well as a multi-layer structure made of a heat-resistant metal film and a low-resistivity film. Then, step S402 is executed.

In step S402, the first insulative layer, the active layer, and the second metal layer are deposited on the substrate having the scanning line thereon. The active layer and the second metal layer are patterned to form the data line and the thin-film field-effect transistor onto the second metal layer. The input of the thin-film field-effect transistor is connected to the data line. The control terminal of the thin-film field-effect transistor is connected to the scanning line. Preferably, the material of the first insulative layer includes silicon nitride (SiNx) or silicon oxide (SiOx). Preferably, the material of the active layer is poly-silicon. Preferably, the second metal layer is made of an aluminum metal layer and a molybdenum metal layer. Other materials such as Al, Ag, Cu, Mo, Cr, W, Ta, Ti, metal nitride, or any combination thereof can also be utilized, as well as a multi-layer structure made of a heat-resistant metal film and a low-resistivity film. Then, step S403 is executed.

In step S403, the second insulative layer is deposited on the substrate having the thin-film field-effect transistor and the data line thereon. The contact hole is formed by patterning the second insulative layer. The thickness of the insulative layer on the first area of the array substrate is less than the thickness of the insulative layer on the second area of the array substrate. The insulative layer includes the first insulative layer and the second insulative layer. The pixel electrode corresponds to the first area of the array substrate. The data line, the scanning line, and the thin-film field-effect transistor correspond to the second area of the array substrate. Then, step S404 is executed.

In step S404, the transparent electrode layer is deposited on the substrate having the contact hole thereon. The pixel electrode is formed on the first area of the array substrate by patterning the transparent electrode layer. The output of the thin-film field-effect transistor is connected with the pixel electrode by the contact hole, as shown in FIGS. 2A to 2C. Since the thickness of the insulative layer on the first area of the array substrate is less than the thickness of the insulative layer on the second area of the array substrate, a distance between the color film substrate and the array substrate can be further reduced based on the guarantee of a distance between a color film substrate and the pixel electrode on the first area of the array substrate. In this way, a distance between the color film substrate and the thin-film field-effect transistor on the second area of the array substrate is reduced, thereby a liquid crystal content for filling a space between the color film substrate and the second area of the array substrate can be reduced, thus the liquid crystal usage of the LCD panel is reduced.

In step S403, preferably, the thickness of the insulative layer on the first area of the array substrate is zero by a patterning process. In step S404, the insulative layer is only deposited on the second area of the array substrate, and the pixel electrode is directly deposited on the substrate, as shown in FIGS. 3A to 3C. At this point, the distance between the color film substrate and the thin-film field-effect transistor on the second area of the array substrate can be maximally reduced, thereby maximally reducing the liquid crystal content needed for filling the space between the color film substrate and the second area of the array substrate, thus reducing the liquid crystal usage of the LCD panel.

In this way, the method according to the preferred embodiment for manufacturing the array substrate is completed.

In the method according to the preferred embodiment for manufacturing the array substrate, the liquid crystal usage of the LCD panel is reduced by reducing the thickness of the insulative layer on the first area of the array substrate.

The present invention further provides an LCD device which uses the above LCD panel. The principle of the LCD device is the same as the principle described in the preferred embodiment of the above LCD panel, please refer to descriptions in the preferred embodiment of the above LCD panel.

Therefore, the LCD panel, the manufacturing method for the same, the liquid crystal usage is reduced by reducing the thickness of the insulative layer on the first area of the array substrate in the LCD device of the present invention, thereby solving a technical problem of poor display performance or higher costs of the existing LCD panel and the LCD device thereof.

It should be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display (LCD) panel, comprising: an array substrate, a color film substrate, and a liquid crystal layer sandwiched between the array substrate and the color film substrate, wherein the array substrate comprises:
a substrate;
a data line for transferring a data signal;
a scanning line for transferring a scanning signal;
a pixel electrode for applying a deflection voltage to the liquid crystal layer;
a thin-film field-effect transistor for applying the data signal to the pixel electrode; and
an insulative layer disposed on the substrate, the insulative layer being for providing a separation between the data line, the scanning line, the pixel electrode, and the thin-film field-effect transistor,
wherein the pixel electrode corresponds to a first area of the array substrate; the data line, the scanning line, and the thin-film field-effect transistor correspond to a second area of the array substrate, and a thickness of the insulative layer on the first area is less than a thickness of the insulative layer on the second area.

2. The LCD panel of claim 1, wherein the insulative layer is only deposited on the second area.

3. The LCD panel of claim 2, wherein the pixel electrode is directly deposited on the substrate when the insulative layer is only deposited on the second area.

4. The LCD panel of claim 1, wherein an input of the thin-film field-effect transistor is connected to the data line, an output of the thin-film field-effect transistor is connected with the pixel electrode by a contact hole, and a control terminal of the thin-film field-effect transistor is connected to the scanning line.

5. The LCD panel of claim 1, wherein the material of the insulative layer includes silicon nitride or silicon oxide.

6. A method for manufacturing an array substrate, comprising:
depositing a first metal layer onto a substrate, and then forming a scanning line by a patterning process;
depositing a first insulative layer, an active layer, and a second metal layer, and then forming a data line and a thin-film field-effect transistor by a patterning process;
depositing a second insulative layer, and then forming a contact hole by a patterning process, and a thickness of the insulative layer on a first area of the array substrate being less than a thickness of the insulative layer on a second area of the array substrate, wherein the insulative layer includes the first insulative layer and the second insulative layer, and the data line, the scanning line, and the thin-film field-effect transistor correspond to the second area of the array substrate; and
depositing a transparent electrode layer, and then forming a pixel electrode onto the first area of the array substrate by a patterning process.

7. The method for manufacturing the array panel of claim 6, wherein the thickness of the insulative layer on the first area of the array substrate is zero.

8. The method for manufacturing the array panel of claim 7, wherein the pixel electrode is directly deposited on the substrate when the thickness of the insulative layer on the first area of the array substrate is zero.

9. The method for manufacturing the array panel of claim 6, wherein an input of the thin-film field-effect transistor is connected to the data line, an output of the thin-film field-effect transistor is connected with the pixel electrode by the contact hole, and a control terminal of the thin-film field-effect transistor is connected to the scanning line.

10. The method for manufacturing the array panel of claim 6, wherein the material of the first metal layer includes aluminum metal and molybdenum metal.

11. The method for manufacturing the array panel of claim 6, wherein the material of the insulative layer includes silicon nitride or silicon oxide.

12. The method for manufacturing the array panel of claim 6, wherein the material of the active layer is poly-silicon.

13. The method for manufacturing the array panel of claim 6, wherein the material of the second metal layer includes aluminum metal and molybdenum metal.

14. A liquid crystal display (LCD) device, comprising: a backlight module and an LCD panel, the LCD panel comprising: an array substrate, a color film substrate, and a liquid crystal layer sandwiched between the array substrate and the color film substrate, wherein the array substrate comprises:
a substrate;
a data line for transferring a data signal;
a scanning line for transferring a scanning signal;
a pixel electrode for applying a deflection voltage to the liquid crystal layer;
a thin-film field-effect transistor for applying the data signal to the pixel electrode; and
an insulative layer disposed on the substrate, the insulative layer being for providing a separation between the data line, the scanning line, the pixel electrode, and the thin-film field-effect transistor,
wherein the pixel electrode corresponds to a first area of the array substrate, the data line, the scanning line, and the thin-film field-effect transistor correspond to a second area of the array substrate, and a thickness of the insulative layer on the first area is less than a thickness of the insulative layer on the second area.

15. The LCD device of claim 14, wherein the insulative layer is only deposited on the second area.

16. The LCD device of claim 15, wherein the pixel electrode is directly deposited on the substrate when the insulative layer is only deposited on the second area.

17. The LCD device of claim 14, wherein an input of the thin-film field-effect transistor is connected to the data line, an output of the thin-film field-effect transistor is connected with the pixel electrode by a contact hole, and a control terminal of the thin-film field-effect transistor is connected to the scanning line.

18. The LCD device of claim 14, wherein the material of the insulative layer includes silicon nitride or silicon oxide.
